(19) United States
(12) Patent Application Publication
(10) Pub. No.: US 2026/0162275 A1
(43) Pub. Date: Jun. 11, 2026

(54) IMAGE INSPECTION APPARATUS

(71) Applicant: Keyence Corporation, Osaka (JP)

(72) Inventors: Xinliang ZHAO, Osaka (JP); Mingyu LI, Osaka (JP)

(73) Assignee: Keyence Corporation, Osaka (JP)

(21) Appl. No.: 19/370,807

(22) Filed: Oct. 28, 2025

(30) Foreign Application Priority Data
Dec. 5, 2024 (JP) 2024-212050

(51) Int. Cl. G06T 7/13; G06T 7/00

(52) U.S. Cl. CPC G06T 7/13; G06T 7/0004; G06T 2207/20081; G06T 2207/30164

(57) ABSTRACT

An image inspection apparatus capable of detecting a fine defect without excessively increasing the resolution of images input to a machine-learned segmentation model. The image inspection apparatus includes an information generation unit that generates defect information based on an annotation specifying a defect region in the training image; a training execution unit that trains a machine learning segmentation model; and an inspection execution unit that executes a trained machine learning model. The training execution unit determines whether to divide the training image according to the detection sensitivity setting of the defect region and, when division is required, the training execution unit divides the training image by a predetermined batch size and inputs the divided training image to the machine learning model.

### CROSS-REFERENCE TO RELATED APPLICATIONS

The present application claims foreign priority based on Japanese Patent Application No. 2024-212050, filed Dec. 5, 2024, the contents of which are incorporated herein by reference.

### BACKGROUND OF THE INVENTION

### 1. Technical Field

The present invention relates to an image inspection apparatus.

### 2. Description of the Related Art

A device that causes a machine learning model to learn so that a defective portion of a defective product is extracted using a non-defective product image at a workpiece production site is known (for example, see JP2023-077054A).

In order to improve the accuracy of the boundary of the defective portion, it is conceivable to use a machine learning model that is a segmentation model for classifying image data in units of pixels instead of the machine learning model disclosed in JP2023-077054A.

### SUMMARY OF THE INVENTION

In the machine learning model, the resolution (size) of the input image that can be processed by the network of the machine learning model is determined.

Therefore, in the image inspection of the workpiece, in a case where the resolution of the workpiece image in which the workpiece appears is higher than the resolution of the input image processable by the network of the machine learning model, generally, the resolution of the workpiece image in which the workpiece appears is reduced to match the resolution of the input image processable by the network of the machine learning model, and then the workpiece image is input to the machine learning model.

However, when the resolution of the workpiece image is reduced, there is a possibility that a defect that has been seen before the resolution is reduced cannot be seen and appropriate training cannot be performed.

In order to solve the above concern, if the resolution of the input image that can be processed by the network of the machine learning model is matched with the assumed maximum resolution of the workpiece image, the required specification (for example, the memory capacity) of the processing device necessary for training of the machine learning model increases, and it takes time to train the machine learning model, which can be an introduction barrier of the image inspection apparatus.

In view of the above problems, an object of the present invention is to provide an image inspection apparatus capable of detecting a fine defect without excessively increasing the resolution of an input image that can be processed by a network of a machine learning model.

For example, an image inspection apparatus according to the present invention is an image inspection apparatus that executes a machine learning model in which a parameter is updated by machine learning based on a training image presented by a user.

The image inspection apparatus includes: a display unit that displays a workpiece image in which a workpiece appears; an input unit that receives defect information corresponding to the workpiece image to be the training image on the basis of an annotation that specifies a defect region included in the displayed workpiece image; a training execution unit that trains the machine learning model, which is a segmentation model that classifies image data in pixel units; and an inspection execution unit that executes the trained machine learning model and causes the display unit to display a defect region of an inspection image in which a workpiece to be inspected appears as an execution result. When determining whether or not to divide the training image according to the detection sensitivity setting of the defect region and determining to divide the training image, the training execution unit divides the training image by a predetermined batch size and inputs the divided training image to the machine learning model.

Other features, elements, steps, advantages, and characteristics will be more apparent from the following detailed description and the accompanying drawings.

According to the present invention, it is possible to provide an image inspection apparatus capable of detecting a fine defect without excessively increasing the resolution of an input image that can be processed by a network of a machine learning model.

### BRIEF DESCRIPTION OF THE DRAWINGS

FIG. 1 is a diagram illustrating a first configuration example (controller type) of an appearance inspection apparatus;

FIG. 2 is a diagram illustrating a second configuration example (smart camera type) of the appearance inspection apparatus;

FIG. 3 is a diagram illustrating a usage form of a removable memory in the second configuration example;

FIG. 4 is a diagram illustrating input/output processing in each of a training stage and an operation stage;

FIG. 5 is a diagram illustrating a first example of training processing of a segmentation model in the appearance inspection apparatus of the second configuration example;

FIG. 6 is a diagram illustrating a divided image;

FIG. 7 is a diagram illustrating a second example of training processing of a segmentation model in the appearance inspection apparatus of the second configuration example;

FIG. 8 is a diagram illustrating a graphical user interface (GUI) transition in the first example (FIG. 5) of the training processing of the segmentation model;

FIG. 9 is a diagram illustrating a screen on which a size display 9 representing a size according to automatic setting of detection sensitivity of a defect region is displayed in a superimposed manner on a training image;

FIG. 10 is a diagram illustrating a GUI transition in the second example (FIG. 7) of the training processing of the segmentation model; and

FIG. 11 is a diagram illustrating an example of an inspection result of an inspection image.

### DETAILED DESCRIPTION

Hereinafter, embodiments of the present invention will be described in detail with reference to the drawings. Note that the following description of preferred embodiments is merely exemplary in nature, and is not intended to limit the present invention, its application, or its use.

### Configuration of Appearance Inspection Apparatus 1 (First Configuration Example)

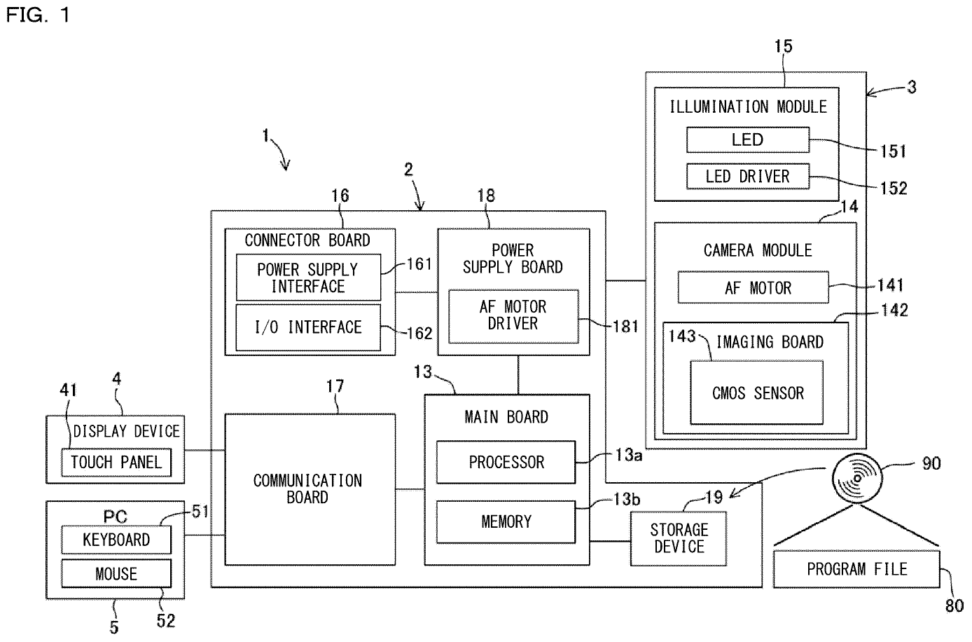

FIG. 1 is a schematic diagram illustrating a first configuration example (controller type) of an appearance inspection apparatus 1 according to an embodiment of the present invention. The appearance inspection apparatus 1 is an apparatus for performing quality determination of a workpiece image acquired by capturing an image of a workpiece to be inspected, such as various components and products, and outputting a result of the quality determination to an external device (not illustrated) connected to the external inspection apparatus 1, and can be used at a production site such as a factory. Specifically, a machine learning network is constructed inside the appearance inspection apparatus 1, and this machine learning network is generated by training at least one of a non-defective product image corresponding to a non-defective product and a defective product image corresponding to a defective product. A workpiece image obtained by capturing an image of a workpiece to be inspected is input to the generated machine learning network, and quality determination of the workpiece image can be performed by the machine learning network. Note that the appearance inspection apparatus 1 can be understood as an aspect of an image inspection apparatus.

The entire workpiece may be an inspection target, or only a part of the workpiece may be an inspection target. Further, one workpiece may include a plurality of inspection targets. The workpiece image may include a plurality of workpieces.

The appearance inspection apparatus 1 includes a control unit 2 serving as an apparatus main body, an imaging unit 3, a display device (display unit) 4, and a personal computer 5. The control unit 2 can be understood as a controller that controls the appearance inspection apparatus 1. The personal computer 5 is not essential and can be omitted. Various types of information and images can be displayed using the personal computer 5 instead of the display device 4, and the function of the personal computer 5 can be incorporated in the control unit 2 or the display device 4.

In FIG. 1, the control unit 2, the imaging unit 3, the display device 4, and the personal computer 5 are described as an example of the configuration of the appearance inspection apparatus 1, but any plurality of these may be combined and integrated. For example, the control unit 2 and the imaging unit 3 can be integrated, or the control unit 2 and the display device 4 can be integrated. Note that a second configuration example (smart camera type) in which the control unit 2 and the imaging unit 3 are integrated will be described in detail later.

In addition, the control unit 2 may be divided into a plurality of units and a part thereof may be incorporated into the imaging unit 3 or the display device 4, or the imaging unit 3 may be divided into a plurality of units and a part thereof may be incorporated into another unit. Alternatively, a function as the control unit 2 can be implemented in the personal computer 5 by executing control software of the imaging unit 3 by the personal computer 5. In this case, the imaging unit 3 and the personal computer 5 can be connected without the control unit 2.

### Configuration of Imaging Unit 3

The imaging unit 3 includes a camera module (imaging section) 14 and an illumination module (illumination section) 15, and is a unit that executes acquisition of a workpiece image. The camera module 14 includes an auto focus (AF) motor 141 that drives an imaging optical system, and an imaging board 142. The AF motor 141 is a part that automatically performs focus adjustment by driving a lens of an imaging optical system, and can perform focus adjustment by a conventionally known method such as contrast autofocus. The imaging board 142 includes a complementary metal oxide semiconductor (CMOS) sensor 143 as a light receiving element that receives light incident from the imaging optical system. The CMOS sensor 143 is an imaging sensor configured to be able to acquire a color image. Instead of the CMOS sensor 143, for example, a light receiving element such as a charge coupled device (CCD) sensor can be used.

The illumination module 15 includes a light emitting diode (LED) 151 as a light emitter that illuminates an imaging region including a workpiece, and an LED driver 152 that controls the LED 151. The light emission timing, the light emission time, and the light emission amount of the LED 151 can be arbitrarily controlled by the LED driver 152. The LED 151 may be provided integrally with the imaging unit 3, or may be provided as an external illumination unit separately from the imaging unit 3.

### Configuration of Display Device 4

The display device 4 includes a display panel including, for example, a liquid crystal panel, an organic electro luminescence (EL) panel, or the like. The workpiece image, the user interface image, and the like output from the control unit 2 are displayed on the display device 4. In a case where the personal computer 5 has a display panel, the display panel of the personal computer 5 can be used instead of the display device 4.

### Operation Device

Examples of the operation device for the user to operate the appearance inspection apparatus 1 include, but are not limited to, a keyboard 51 and a mouse 52 of the personal computer 5, and any device may be used as long as the device can accept various operations by the user. For example, a pointing device such as a touch panel 41 included in the display device 4 is also included in the operation device.

A user's operation of the keyboard 51 or the mouse 52 can be detected by the control unit 2. The touch panel 41 is, for example, a conventionally known touch operation panel equipped with a pressure-sensitive sensor, and a user's touch operation can be detected by the control unit 2. The same applies to a case where another pointing device is used.

### Configuration of Control Unit 2

The control unit 2 includes a main board 13, a connector board 16, a communication board 17, and a power supply board 18. The main board 13 is provided with a processor 13a. The processor 13a controls the operations of the connected boards and modules. For example, the processor 13a outputs an illumination control signal for controlling turning on/off of the LED 151 to the LED driver 152 of the illumination module 15. The LED driver 152 switches on/off of the LED 151 and adjusts the lighting time according to the illumination control signal from the processor 13a, and adjusts the light amount and the like of the LED 151.

In addition, the processor 13a outputs an imaging control signal for controlling the CMOS sensor 143 to the imaging board 142 of the camera module 14. In response to an imaging control signal from the processor 13a, the CMOS sensor 143 starts capture of an image and performs capture of an image by adjusting the exposure time to an arbitrary time. That is, the imaging unit 3 captures an image of the inside of the visual field range of the CMOS sensor 143 according to the imaging control signal output from the processor 13a, and captures an image of the workpiece when the workpiece is within the visual field range, but can also capture an image of an object other than the workpiece when the object is within the visual field range. For example, the appearance inspection apparatus 1 can capture a non-defective product image corresponding to a non-defective product and a defective product image corresponding to a defective product by the imaging unit 3 as images for training of the machine learning network. The image for training may not be an image captured by the imaging unit 3, and may be an image captured by another camera or the like.

On the other hand, when the appearance inspection apparatus 1 is in operation, the imaging unit 3 can image a workpiece. Furthermore, the CMOS sensor 143 is configured to be able to output a live image, that is, a currently captured image at a short frame rate as needed.

When the imaging by the CMOS sensor 143 is finished, the image signal output from the imaging unit 3 is input to a processor 13a of the main board 13, processed, and stored in a memory 13b of the main board 13. Details of specific processing contents by the processor 13a of the main board 13 will be described later. Note that the main board 13 may be provided with a processing device such as a field programmable gate array (FPGA) or a digital signal processor (DSP). The processor 13a may be integrated with a processing device such as an FPGA or a DSP.

The connector board 16 is a portion that receives power supply from the outside via a power connector (not illustrated) provided in the power supply interface 161. The power supply board 18 is a portion that distributes power received by the connector board 16 to each board, module, and the like, and specifically distributes power to the illumination module 15, the camera module 14, the main board 13, and the communication board 17. The power supply board 18 includes an AF motor driver 181. The AF motor driver 181 supplies drive power to the AF motor 141 of the camera module 14 to achieve autofocus. The AF motor driver 181 adjusts power to be supplied to the AF motor 141 in accordance with an AF control signal from the processor 13a of the main board 13. In addition, the connector board 16 is a portion that outputs an inspection result to an external device via an I/O terminal provided in an I/O interface 162.

The communication board 17 is a part that executes communication between the main board 13 and the display device 4 and the personal computer 5, communication between the main board 13 and an external control device (not illustrated), and the like. Examples of the external control device include a programmable logic controller and the like. The communication may be wired or wireless, and any communication form can be realized by a conventionally known communication module.

The control unit 2 is provided with a storage device 19 including, for example, a solid state drive (SSD), a hard disk drive (HDD), or the like. The storage device 19 stores a program file 80, a setting file, and the like (software) for enabling each control and processing described later to be executed by hardware. The program file 80 and the setting file are stored in a storage medium 90 such as an optical disk, for example, and the program file 80 and the setting file stored in the storage medium 90 can be installed in the control unit 2. The program file 80 may be downloaded from an external server using a communication line. Furthermore, the storage device 19 can also store, for example, the image data, parameters for constructing a machine learning network of the appearance inspection apparatus 1, and the like.

That is, the processor 13a of the appearance inspection apparatus 1 is configured to read parameters and the like stored in the storage device 19 to construct a machine learning network, input a workpiece image obtained by imaging a workpiece to be inspected to the constructed machine learning network, and perform quality determination of the workpiece on the basis of the input workpiece image. By using the appearance inspection apparatus 1, it is possible to execute an appearance inspection method for performing quality determination of a workpiece on the basis of a workpiece image. The machine learning network may be understood as a machine learning model. In the present embodiment, for convenience of description, the appearance inspection apparatus 1 executes quality determination, but may execute determination of classifying a workpiece image into an arbitrary class. That is, the “good product” and the “defective product” described for the workpiece image may be handled as arbitrary classes.

### Configuration of Appearance Inspection Apparatus 1 (Second Configuration Example)

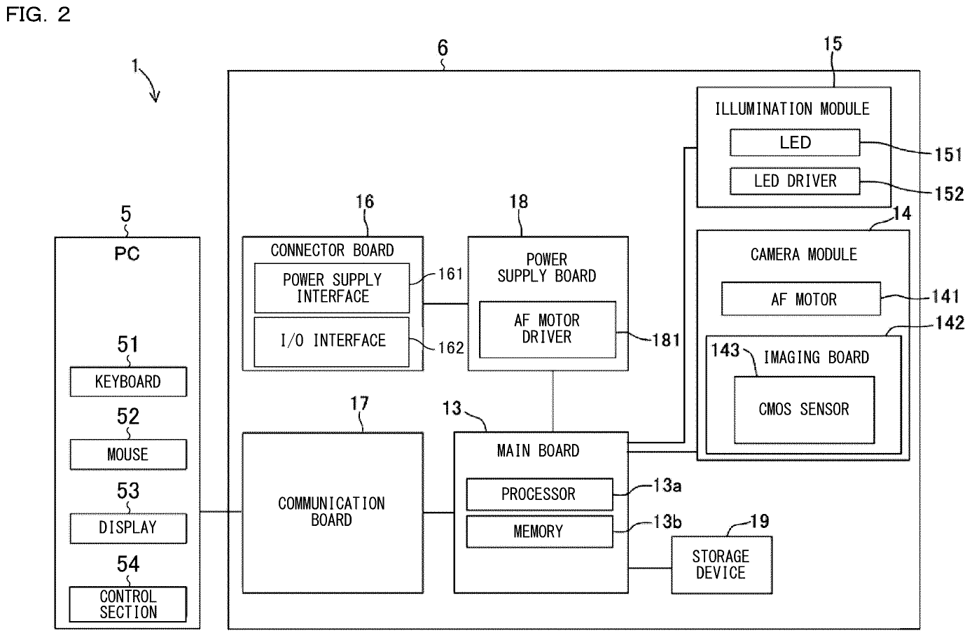

FIG. 2 is a diagram illustrating a second configuration example (smart camera type) of the appearance inspection apparatus 1. The appearance inspection apparatus 1 of the drawing includes a smart camera 6 instead of the control unit 2 and the imaging unit 3 described above. In addition, the personal computer 5 may include a display 53 in addition to the keyboard 51 and the mouse 52 described above. In addition, in the drawing, a control section 54 is clearly illustrated as a component of the personal computer 5.

The personal computer 5 can be understood as an example of a UI device that is connected to the smart camera 6 and receives a user's operation. For example, the personal computer 5 receives a user's operation to set the smart camera 6 and issue a driving instruction. That is, in the appearance inspection apparatus 1 of the second configuration example, among the various functions performed by the control unit 2 of the first configuration example (FIG. 1), the setting function of the smart camera 6 is transferred to the personal computer 5.

The display 53 displays the inspected image acquired by the smart camera 6 and displays a GUI for performing various settings of the smart camera 6. Note that the inspected image can be understood as a workpiece image subjected to inspection by the smart camera 6. In other words, the inspected image may be understood as a driving history image acquired when the smart camera 6 is in the driving mode.

The control section 54 displays the inspected image and the GUI on the display 53. Furthermore, the control section 54 can receive a user's operation via the keyboard 51 and the mouse 52. Furthermore, the control section 54 also has a function of performing setting of the smart camera 6 and a driving instruction according to a user's operation.

The smart camera 6 receives setting and driving instructions from the personal computer 5. In the smart camera 6, the control unit 2 and the imaging unit 3 described above are integrated. That is, the smart camera 6 includes the main board 13, the camera module 14, the illumination module 15, the connector board 16, the communication board 17, the power supply board 18, and the storage device 19 described above.

For example, the processor 13a mounted on the main board 13 functions as an inspection unit that executes inspection of a workpiece image. The inspection of the workpiece image may be performed on the basis of setting information set according to a setting operation received by the personal computer 5. The setting information may be various parameters of the setting tool.

The workpiece image subjected to the inspection by the processor 13a, that is, the inspected image is held in the memory 13b, but may be written in the storage device 19. In this manner, the memory 13b or the storage device 19 functions as a storage unit that stores the inspected image.

Note that the internal configuration of the smart camera 6 is merely an example. For example, aggregation or division of the boards is arbitrary.

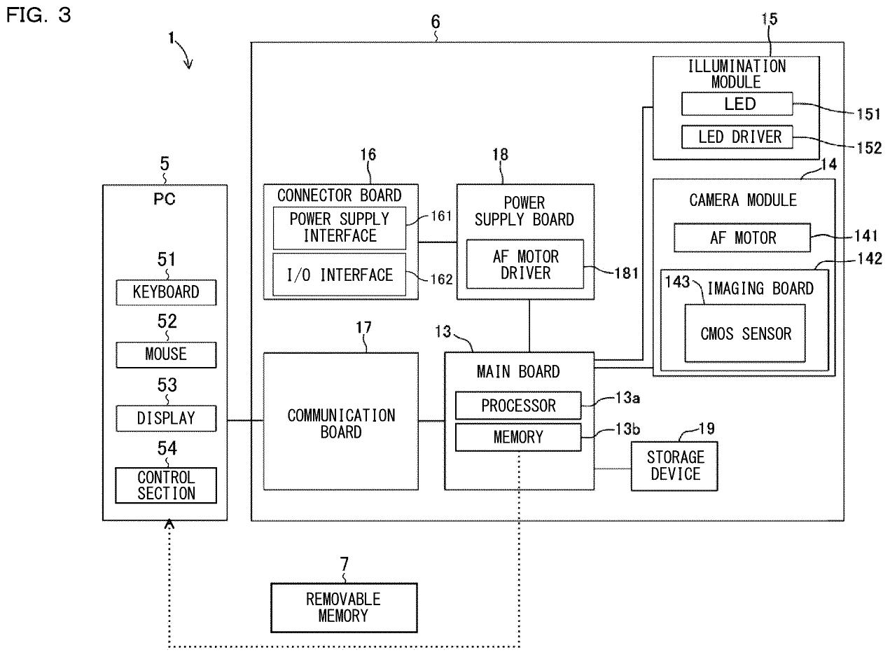

FIG. 3 is a diagram illustrating a usage form of a removable memory 7 in the appearance inspection apparatus 1 of the second configuration example (FIG. 2). As illustrated in the drawing, the removable memory 7 may be attached to and detached from the memory 13b of the smart camera 6 as a storage unit that stores the inspected image and the inference result thereof. The removable memory 7 is detachable not only from the smart camera 6 but also from the personal computer 5. The personal computer 5 can designate the removable memory 7 attached to the smart camera 6 as a storage destination of the inspected image and the inference result thereof. As the removable memory 7, for example, an SD memory card can be suitably used.

### Input/output Processing

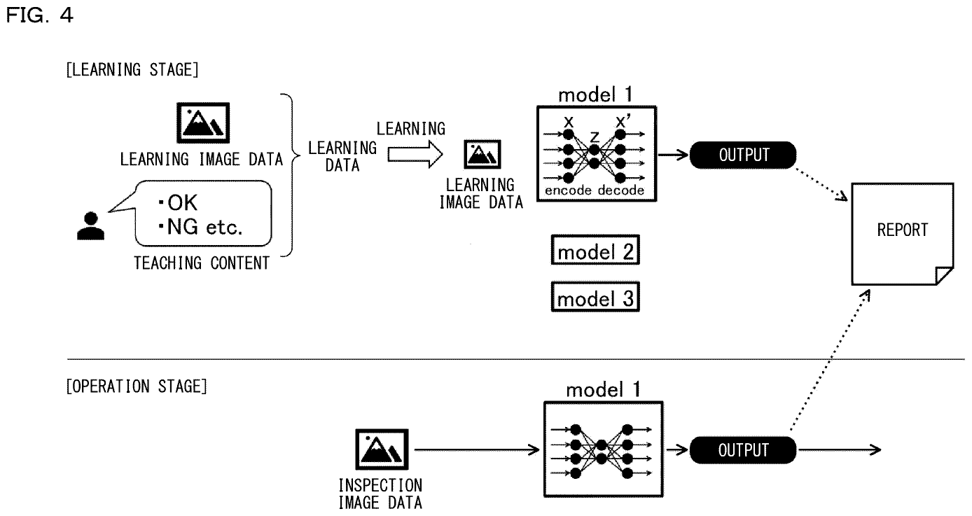

FIG. 4 is a diagram illustrating input/output processing in each of a training stage and an operation stage in the appearance inspection apparatus 1. As illustrated in the drawing, in a training stage of the appearance inspection apparatus 1, training of a machine learning model is performed on the basis of training data presented by a user (customer viewed from a vendor).

The training data includes training image data and teaching contents. The training image data includes at least one of non-defective product image data and defective product image data. The teaching contents include labels indicating classes such as “this image data is a non-defective product”, “this image data is a defective product”, and “this portion is abnormal”.

In the above training, the parameter of the machine learning model is updated (adjusted) so that the output of the machine learning model approaches the expected value according to the teaching content. A plurality of machine learning models may be prepared (model1 to model3). With such a configuration, it is possible to arbitrarily select the training target or the operation target according to the application of the appearance inspection apparatus 1.

Note that the user does not necessarily have to perform all the steps in the above training. For example, training with a relatively large amount of calculation may be completed on the vendor side before shipment of the appearance inspection apparatus 1, and only training with a relatively small amount of calculation may be performed on the user side before operation of the appearance inspection apparatus 1. In the present specification, training performed by the vendor side before shipment is referred to as pre-shipment training, and training performed by the user side before operation of the appearance inspection apparatus 1 is referred to as customer training.

That is, the machine learning model of the appearance inspection apparatus 1 may include a parameter fixed portion. The parameter fixed portion is a layer in which a parameter obtained by pre-shipment training on the vendor side is fixed, in other words, a layer in which customer training on the user side is unnecessary.

Since the machine learning model of the appearance inspection apparatus 1 includes the parameter fixed portion, it is not necessary for the user to prepare a facility having a high processing capability (such as a graphics processing unit (GPU)) or for a vendor to provide an advanced training environment by the GPU or the like as a cloud service (such as SaaS). Therefore, the introduction barrier of the appearance inspection apparatus 1 is lowered.

As described above, the above training should be broadly understood as not only training with a large calculation amount represented by deep learning but also training with a small calculation amount (customer training).

On the other hand, in the operation stage of the appearance inspection apparatus 1, the inspection image data is inspected using the trained machine learning model. The inspection includes region division (segmentation). The inspection may include classification of images, abnormality detection, and the like in addition to region division.

In the region division of the image, classification is performed for each pixel forming the image, and the region is divided for each classification. In the quality determination by the image inspection, the appearance inspection apparatus 1 classifies the image into abnormal/normal regions for each pixel forming the image as the region division of the image, and determines the object (workpiece) to be depicted to the image as the defective product when the region including the pixels classified as abnormal is equal to or larger than a certain area. In the classification of the image, classification is performed for each image or each region designated in the image. As the classification of the image in the quality determination by the image inspection, the appearance inspection apparatus 1 classifies the image in which the object (workpiece) appears into the non-defective product image and the defective product image, and determines that the object (workpiece) appearing in the non-defective product image is the non-defective product and the object (workpiece) appearing in the defective product image is the defective product. In the abnormality detection of the image, an abnormal portion is extracted from the image. For example, abnormality detection by an auto encoder is well known. The auto encoder can be understood as a machine learning model trained (parameter adjusted) so that an abnormal portion included in an abnormal image easily floats when a normal image and an abnormal image are input. The appearance inspection apparatus 1 determines whether the image is a non-defective product image or a defective product image on the basis of the abnormality degree and the area of the abnormality detected by the abnormality detection, thereby determining the quality of the object (workpiece) appearing in the image.

In addition, the appearance inspection apparatus 1 includes a report output unit (model evaluation result generation unit) that outputs a report display on the basis of the output result of the machine learning model in the training stage or the operation stage. That is, the target image data input to the machine learning model when the report is displayed may be at least one of the training image data and the inspection image data.

Note that the report output unit can be understood as, for example, one function of editor software executed by the personal computer 5. In other words, the personal computer 5 functions as a report output unit by executing the editor software.

### Training of Segmentation Model

The machine learning model model1 used in the appearance inspection apparatus 1 is a segmentation model that classifies image data in units of pixels. The machine learning model model1 outputs, on the basis of a label indicating a first class (abnormality) given to training image data, image data in which a region belonging to the first class in an image region of input inspection image data is distinguishable from a region not belonging to the first class.

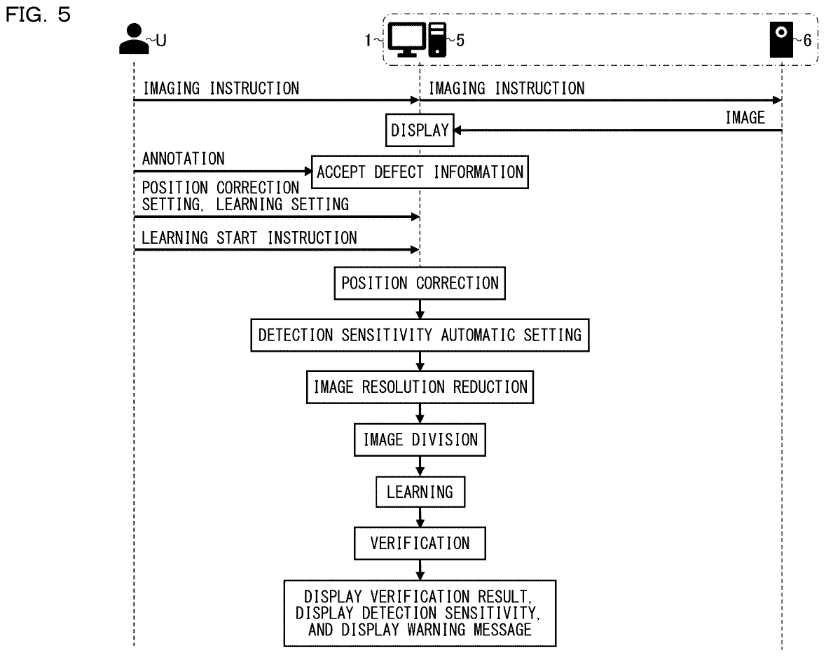

FIG. 5 is a diagram illustrating a first example of training processing of a segmentation model in the appearance inspection apparatus 1 of the second configuration example (FIG. 2). In the drawing, operations of the user U, the personal computer 5, and the smart camera 6, and information transmission therebetween are schematically depicted. The subject that controls the operation of the personal computer 5 can be understood as the control section 54 described above.

When the user U instructs the smart camera 6 to capture an image via the personal computer 5, the smart camera 6 captures an image of the workpiece and acquires a workpiece image (image data). The workpiece image is sent to the personal computer 5, displayed on the display 53, and stored in the personal computer 5.

When the user U performs annotation for specifying the defect region included in the workpiece image displayed on the display 53, the personal computer 5 generates and stores the defect information corresponding to the workpiece image on the basis of the annotation. In the present example, the user U performs annotation for specifying a plurality of defect regions having different sizes included in the workpiece image displayed on the display 53.

Furthermore, in the present example, the user U instructs the personal computer 5 to start training after performing position correction setting for turning on a position correction function and performing training setting for turning on a detection sensitivity automatic setting function.

When instructed to start training by the user U, the personal computer 5 specifies the position of the workpiece appearing in the workpiece image by pattern search, and performs position correction to move the workpiece appearing in the workpiece image to a fixed position on the workpiece image based on the specified position.

Next, the personal computer 5 automatically sets the detection sensitivity setting of the defect region on the basis of the defect information. More specifically, the personal computer 5 automatically sets the detection sensitivity setting of the defect region on the basis of the minimum size of the defect region included in the defect information. In the present example, the personal computer 5 sets the detection sensitivity setting of the defect region so that the machine learning model model1 is a segmentation model capable of detecting the defect region having the same size as the minimum size of the defect region included in the defect information by training.

Next, the personal computer 5 reduces the resolution of the workpiece image according to the detection sensitivity setting of the defect region. Specifically, the personal computer 5 reduces the resolution of the workpiece image to such an extent that the minimum size defect region included in the defect information can be detected even in the workpiece image after the resolution reduction. Therefore, the larger the minimum size of the defect region included in the defect information, the lower the resolution of the workpiece image after the resolution reduction. When the resolution of the workpiece image is reduced, the training speed and the inference speed of the machine learning model model1 are improved. On the other hand, in a case where the detection sensitivity setting of the defect region is set to be extremely high, that is, in a case where the defect region to be detected is very small, it may be difficult to reduce the resolution of the workpiece image. Therefore, the resolution of the workpiece image may not be reduced in a case where the detection sensitivity setting is extremely high. However, in a case where the resolution of the workpiece image is not reduced, the training time and the inference time of the machine learning model model1 become long, and the convenience of the user may be relatively lowered. Therefore, even in a case where it is determined whether to reduce the resolution of the workpiece image according to the detection sensitivity setting, the resolution of the workpiece image may be reduced when the personal computer 5 automatically sets the detection sensitivity setting of the defect region. For example, this is realized by setting an upper limit value of the automatically set detection sensitivity setting to be lower than a threshold value used for determining whether or not to reduce the resolution. With such a configuration, it is possible to prevent the processing of not reducing the resolution of the workpiece image from being executed without manual setting of the detection sensitivity setting by the user, and the convenience of the user is less likely to be lowered.

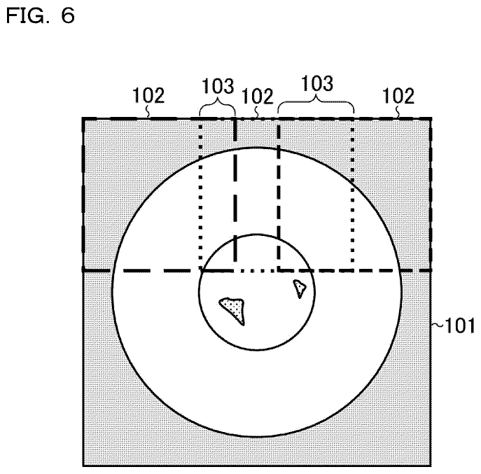

Next, the personal computer 5 divides the workpiece image after the resolution reduction into a predetermined batch size. In this example, as illustrated in FIG. 6, the personal computer 5 divides a workpiece image 101 after the resolution reduction into a plurality of divided images 103 while providing the overlapping region 103 between adjacent divided images 102. Each divided image 102 has a predetermined batch size. In FIG. 6, in order to avoid complication of the drawing, only the divided image 102 corresponding to the upper portion of the workpiece image 101 after the resolution reduction is illustrated, but actually, there are also the divided image 102 corresponding to the central portion of the workpiece image 101 after the resolution reduction and the divided image 102 corresponding to the lower portion of the workpiece image 101 after the resolution reduction.

By providing the overlapping region 103, it is possible to make the division line appearing in the inspection image less noticeable when the smart camera 6 executes the trained machine learning model and causes the display 53 of the personal computer 5 to display the defect region of the inspection image in which the workpiece to be inspected appears as the execution result.

Next, the personal computer 5 performs processing of supplying training data including the divided image 102 and a portion of the defect information corresponding to the divided image 102 to the machine learning model model1 to update the parameters of the machine learning model model1 on each divided image 102, thereby training the machine learning model model1. Under an environment where there is a limitation on the image size that can be input to the model, it is possible to execute training and inference of the machine learning model model1 such that the detection sensitivity setting is not reduced, in other words, a defect region having a small size can also be detected by combining the resolution reduction and the division of the workpiece image, as compared with the case where the workpiece image has an image size equal to or less than the limitation only by the resolution reduction. On the other hand, in a case where the size of the defect region to be detected is extremely large, if training or inference including division of the workpiece image is performed, detection performance may be deteriorated. Therefore, in a case where the detection sensitivity setting may be set extremely low, that is, in a case where the size of the defect region to be detected is extremely large, the workpiece image may not be divided. However, if the workpiece image is not divided and the resolution is excessively reduced, the detection accuracy may be deteriorated. Therefore, even in a case where it is determined whether to divide the workpiece image according to the detection sensitivity setting, the workpiece image may be divided when the personal computer 5 automatically sets the detection sensitivity setting of the defect region. For example, it is realized by setting the lower limit value of the automatically set detection sensitivity setting to be higher than a threshold value used for determining whether or not to divide the image. With such a configuration, it is possible to prevent the processing of not dividing the workpiece image from being executed without manual setting of the detection sensitivity setting by the user, and the detection accuracy of the machine learning model model1 is unlikely to decrease.

When the training of the machine learning model model1 is completed, the personal computer 5 inputs the test image to the trained machine learning model model1 to verify the trained machine learning model model1.

Finally, the personal computer 5 displays the output of the trained machine learning model model1 to which the test image has been input as a verification result, and displays the automatically set detection sensitivity setting of the defect region. A warning message is displayed in a case where the detection sensitivity setting set in each of the workpiece images to be trained varies, or in a case where the size of the defect region used when the detection sensitivity setting is automatically set varies between the workpiece images or within one workpiece image. The warning message is, for example, “A defect having a different size is detected in the training image. In order to improve the tool determination accuracy after training, it is recommended to separate tools”. In a case where the size of the defect region varies, a warning message may be displayed according to the ratio between the maximum size of the defect region and the minimum size of the defect region. For example, a warning message may be displayed in a case where the relative ratio between the maximum size of the defect region and the minimum size of the defect region is equal to or larger than a certain value. With such a configuration, in a case where the variation in the size of the defect region is a variation within a range not affecting the training time and the inference time, and the training accuracy and the inference accuracy of the machine learning model1, the warning message can be prevented from being displayed.

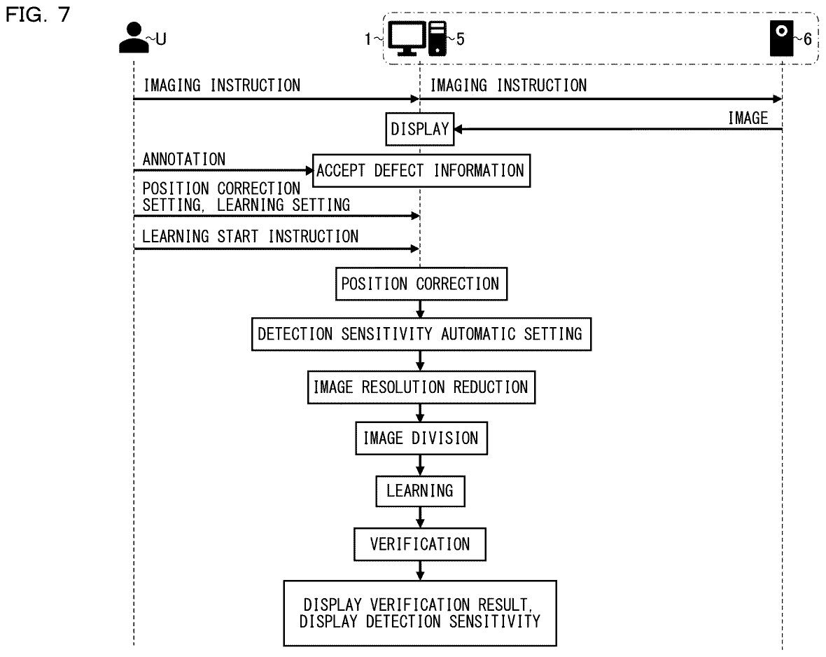

FIG. 7 is a diagram illustrating a second example of training processing of a segmentation model in the appearance inspection apparatus 1 of the second configuration example (FIG. 2). In the drawing, as in the first example (FIG. 5) described above, operations of the user U, the personal computer 5, and the smart camera 6, and information transmission therebetween are schematically depicted. The subject that controls the operation of the personal computer 5 can be understood as the control section 54 described above.

The operation until the user U verifies the trained machine learning model model1 is similar to that of the first example (FIG. 5) except that the user U performs annotation for specifying one defect region included in a workpiece image displayed on the display 53. At this time, in a case where the variation in the detection sensitivity setting set between the workpiece images is small, there is a small possibility that the training and inference of the machine learning model model1 will not be stable, and thus, the warning message is not displayed.

In the present example, the personal computer 5 displays the output of the trained machine learning model model1 to which the test image has been input as the verification result, and displays the automatically set detection sensitivity setting of the defect region.

### Training of Segmentation Model

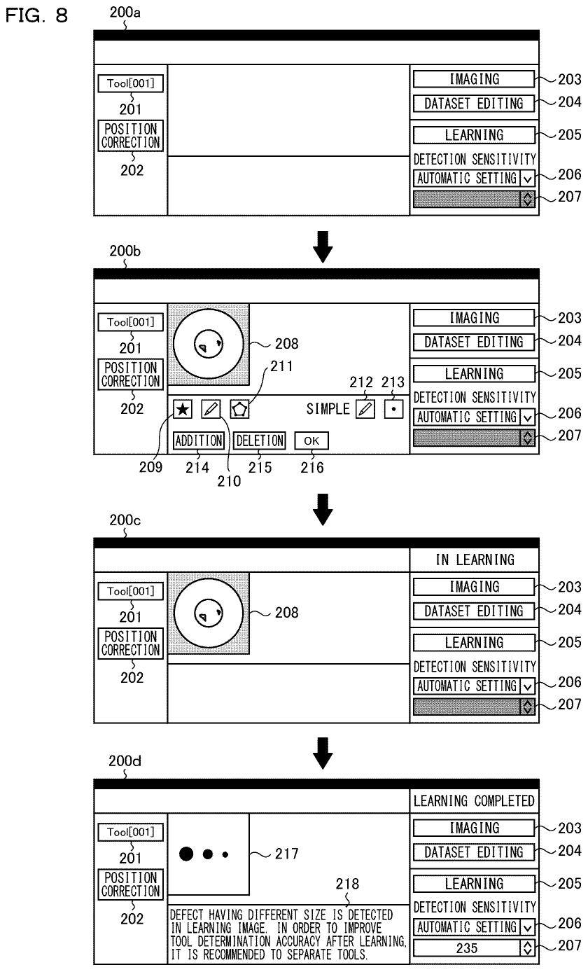

FIG. 8 is a diagram illustrating a GUI transition in the first example (FIG. 5) of the training processing of the segmentation model. When the control program of the smart camera 6 is executed by the personal computer 5 and the user U instructs the personal computer 5 to start the training processing of the segmentation model, the GUI 200 is displayed on the display 53. The display content of the GUI 200 changes according to the user's operation. In the drawing, screens 200a to 200d are illustrated as main display contents of the GUI 200.

In the initial stage of the training processing of the segmentation model, the display content of the GUI 200 is the screen 200a. The screen 200a includes a tool name display 201, a position correction button 202, an imaging button 203, a data set edit button 204, a training button 205, a detection sensitivity setting selection menu 206, and a detection sensitivity display 207.

The tool name display 201 displays the name of the inspection tool (Tool [001] in FIG. 8) using the machine learning model model1 for which training is performed in the current training processing. The name can be changed to an arbitrary name by a user operation.

The position correction button 202 is a button for switching on/off of the position correction function and setting a reference destination in a case where the position correction function is turned on. In FIG. 8, it is displayed in association with Tool [001]. As described above, the position correction function is a function including a step of specifying the position of the workpiece appearing in the workpiece image by pattern search, and it is necessary to set in advance a visual feature to be subjected to pattern search. When the user U presses the position correction button 202, the personal computer 5 accepts the selection of the visual feature to be referred to, and specifies the position of the workpiece appearing in the workpiece image by pattern search on the basis of the selected visual feature.

The imaging button 203 is a button for instructing the smart camera 6 to capture an image and using the workpiece image captured by the smart camera 6 as a training image.

The data set edit button 204 is a button for reading a workpiece image stored in the personal computer 5 and using the workpiece image as a training image.

The training button 205 is a button for instructing start of training.

The detection sensitivity setting selection menu 206 is a button for switching between automatic setting and manual setting. Only the automatic setting is displayed on the screen 200a, but the manual setting can be displayed and selected by a pull-down menu.

The detection sensitivity display 207 displays the detection sensitivity setting. On the screen 200a, since the automatic setting is selected and the automatic setting is not completed, the screen 200a is grayed out.

When the imaging button 203 is clicked by a user operation and the personal computer 5 acquires a training image (a workpiece image captured by the smart camera 6), the screen 200a is switched to the screen 200b.

The screen 200b includes a training image 208, icons 209 to 213 for annotation, an add button 214, a delete button 215, and an OK button 216.

When the icon 209 is selected, the personal computer 5 designates the defect region included in the training image 208 as a free-form painted image formed according to a user operation (drag operation of the user on the mouse).

When the icon 210 is selected, the personal computer 5 designates the defect region included in the training image 208 as a region whose boundary is a free curve formed according to a user operation (drag operation of the user on the mouse). In a case where the free curve is closed, a region surrounded by the free curve is the designated region. In a case where the free curve is open, a region surrounded by the free curve and a line segment connecting the start point and the end point of the free curve is the designated region.

When the icon 211 is selected, the personal computer 5 designates a defect region included in the training image 208 as a region whose boundary is a polygonal line according to a user operation (click operation of the user on the mouse). In a case where the polygonal line is closed, a region surrounded by the polygonal line is the designated region. In a case where the polygonal line is open, a region surrounded by the polygonal line and a line segment connecting a start point and an end point of the polygonal line is a designated region.

When the icon 212 is selected, the personal computer 5 designates a part of the defect region included in the training image 208 with a free curve formed according to a user operation (drag operation of the user on the mouse).

When the icon 213 is selected, the personal computer 5 designates a part of the defect region included in the training image 208 with a dot formed according to a user operation (click operation of the user on the mouse).

When the add button 214 is selected, one defect region can be designated. When the delete button 215 is selected, it is possible to delete the defect region erroneously designated by selecting the defect region erroneously designated. When the OK button 216 is selected, the annotation by the user U is completed.

In a case where any of the icons 209 to 211 is selected, since the annotation by the user U is a precise annotation, the personal computer 5 generates defect information corresponding to the training image 208 with the region itself designated by the annotation as a defect region.

In a case where the icon 212 or the icon 213 is selected, since the annotation by the user U is a simple annotation, the personal computer 5 generates defect information corresponding to the training image 208 by including a minute region having a characteristic amount similar to that of the region designated by the simple annotation in the defect region.

In this example, the user U performs annotation for specifying a plurality of defect regions having different sizes.

Thereafter, when the training button 205 is clicked in a state where the position correction function is set to ON by the position correction button 202 and the automatic setting is selected by the detection sensitivity setting selection menu 206, training is started. When training is started, the screen 200b is switched to the screen 200c.

Then, when training and verification are completed, the screen 200c is switched to the screen 200d. The screen 200d includes a verification result (inspection result obtained by inputting a test image to the trained machine learning model model1) 217 and a warning message 218. On the screen 200d, the detection sensitivity display 207 displays a numerical value indicating the automatically set level of the detection sensitivity. Note that it is preferable that a plurality of defect regions having different sizes appear in the test image so that the verification result can be easily understood.

On the screen 200d, the numerical value displayed on the detection sensitivity display 207 can be changed by a user operation. When the training button 205 is clicked after the numerical value displayed on the detection sensitivity display 207 is changed by the user operation, training is performed again, and the resolution of the training image 208 is reduced according to the detection sensitivity setting of the defect region.

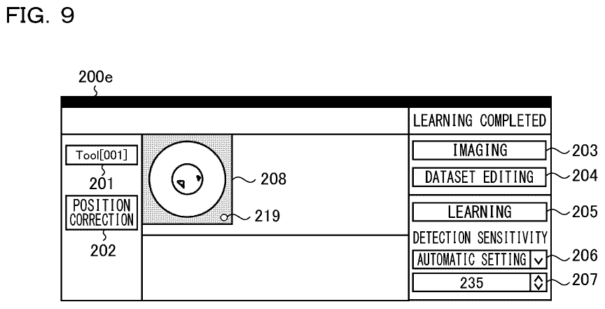

Note that, since it is difficult for the user to intuitively grasp the detection sensitivity of the defect region only with numerical values, the screen 200d may transition to a screen 200e illustrated in FIG. 9. On the screen 200e, a size display 219 indicating a size according to the automatic setting of the detection sensitivity setting of the defect region is displayed in a superimposed manner on the training image 208. The size display 219 can be moved by a user operation, and for example, it is possible to intuitively grasp whether the detection sensitivity setting of the defect region is appropriate by moving the size display 219 to the position of the defect region of the training image 208. Then, by changing the size of the size display 219 by a user operation (for example, drag operation with the mouse on the size display 219 after the position of the size display 219 is fixed), the automatically set detection sensitivity setting of the defect region may be changed. This facilitates the user U to appropriately change the detection sensitivity of the defect region.

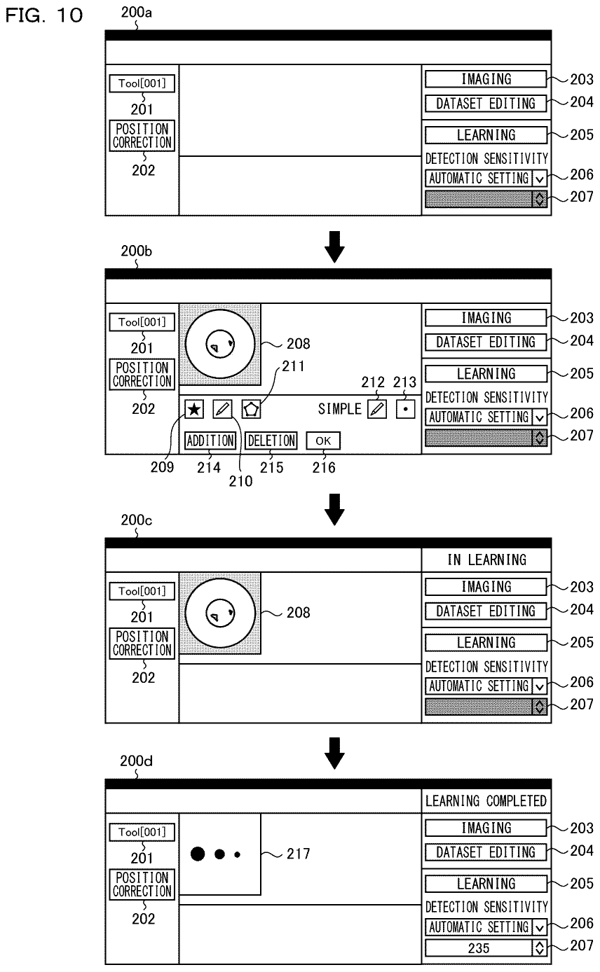

FIG. 10 is a diagram illustrating a GUI transition in the second example (FIG. 7) of the training processing of the segmentation model. The GUI transition in the second example (FIG. 7) of the training processing of the segmentation model is similar to the GUI transition (FIG. 8) in the first example (FIG. 5) of the training processing of the segmentation model except that the warning message 218 is not displayed on the screen 200d.

### Inspection Using Trained Segmentation Model

The personal computer 5 transfers the trained machine learning model model1 to the smart camera 6. The smart camera 6 executes the trained machine learning model model1 and causes the display 53 of the personal computer 5 to display the defect region of the inspection image in which the workpiece to be inspected appears as the execution result. When executing the trained machine learning model model1, the smart camera 6 performs resolution reduction and division on the inspection image similar to resolution reduction and division on the training image 208 in the training processing of the machine learning model model1 (resolution reduction in which the resolution after the resolution reduction is matched between the training image 208 and the inspection image), combines detection results (inference results) for each divided image, and displays a defect region of the inspection image on the display 53 of the personal computer 5. In a case where overlapping regions are provided between adjacent divided images of the inspection image, a weighted average of detection results (inference results) for each divided image is used as a synthesis result in the overlapping region. In the weighted average, the weight may be increased as the distance from the center position of each divided image is shorter.

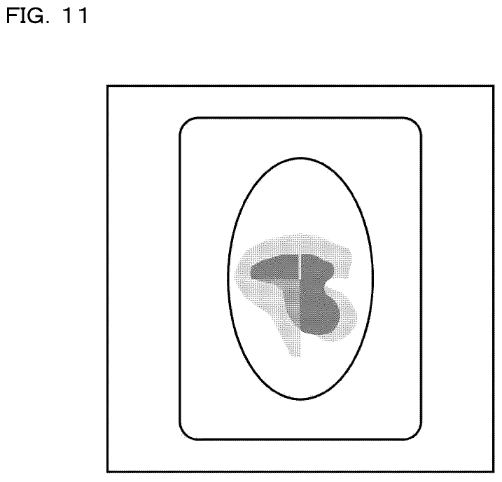

FIG. 11 is an example of an inspection result of the inspection image displayed on the display 53 of the personal computer 5. The image illustrated in FIG. 11 is an image in which the heat map image is superimposed on the inspection image. The heat map image is an image obtained by combining detection results (inference results) for each divided image, and is an image in which accuracy (reliability) of a first class (abnormality) is expressed in gradation regarding hue in units of pixels. In the heat map image, for example, the hue gradually changes from blue to green from lower to higher accuracy (reliability) of the first class (abnormality), and further, when the accuracy (reliability) of the first class (abnormality) increases, the hue gradually changes from green to red. In the heat map image, pixels that are not classified into the first class (abnormality) are transparent. Note that the heat map image may be an image in which accuracy (reliability) of the first class (abnormality) is expressed in a gradation related to lightness (density) in a single color in units of pixels.

An image illustrated in FIG. 11 is an inspection result in a case where, when the smart camera 6 executes the trained machine learning model model1, the inspection image is subjected to four-division in each of the horizontal direction and the vertical direction without providing an overlapping region between the divided images.

By combining the detection results (inference results) for each divided image, the gradation of the heat map image is likely to greatly change in the portion corresponding to the four-division. As a result, in the image illustrated in FIG. 11, a straight line greatly different in gradation from the surroundings or a linear boundary of different gradations appears in at least a part of a portion corresponding to the four-division. That is, in the heat map image, if a straight line whose gradation is greatly different from the surroundings or a linear boundary of different gradations appears, the heat map image can be estimated to be an image obtained by combining detection results (inference results) for each divided image.

### Others

Note that, in addition to the above embodiments, various modifications can be made to various technical features disclosed in the present specification without departing from the spirit of the technical creation.

That is, it should be considered that the above embodiments are illustrative in all respects and not restrictive. In addition, the technical scope of the present invention is defined by the claims, and should be understood to include all modifications falling within the meaning and scope equivalent to the claims.

What is claimed is:

1. An image inspection apparatus that executes a machine learning model in which a parameter is updated by machine learning based on a training image presented by a user, the image inspection apparatus comprising:
a display unit configured to display a workpiece image in which a workpiece appears;
an information generation unit configured to generate defect information corresponding to the workpiece image used as the training image, on a basis of an annotation specifying a defect region included in the displayed workpiece image;
a training execution unit configured to train the machine learning model, the machine learning model being a segmentation model that performs pixel-level classification to segment an input image into regions corresponding to different classes; and
an inspection execution unit configured to execute the trained machine learning model and cause the display unit to display a defect region of an inspection image in which a workpiece to be inspected appears, as an execution result, wherein
the training execution unit
determines whether to divide the training image according to detection sensitivity setting of the defect region, and
when the training execution unit determines to divide the training image, divides the training image by a predetermined batch size and inputting the divided training image to the machine learning model.

2. The image inspection apparatus according to claim 1, wherein the training execution unit reduces resolution of the training image according to the detection sensitivity setting of the defect region, and divides the training image, after the resolution reduction, by the predetermined batch size.

3. The image inspection apparatus according to claim 1, wherein the training execution unit automatically sets the detection sensitivity setting of the defect region based on the defect information.

4. The image inspection apparatus according to claim 3, wherein the training execution unit automatically sets the detection sensitivity setting of the defect region based on a minimum size of the defect region included in the defect information.

5. The image inspection apparatus according to claim 3, wherein the training execution unit determines not to divide the training image when the training execution unit automatically sets the detection sensitivity setting.

6. The image inspection apparatus according to claim 3, wherein the training execution unit allows the automatically set detection sensitivity setting of the defect region to be changed by a user operation.

7. The image inspection apparatus according to claim 1, wherein the training execution unit causes the display unit to display a warning message in a case where a plurality of sizes of the defect region are included in the defect information.

8. The image inspection apparatus according to claim 7, wherein the training execution unit causes the display unit to display the warning message in a case where a relative ratio between a size of a first defect region among the plurality of sizes of the defect region and a size of a second defect region among the plurality of sizes of the defect region is equal to or larger than a certain value.

9. The image inspection apparatus according to claim 1, wherein the training execution unit divides the training image into a plurality of the divided images while providing an overlapping region between adjacent divided images.

10. The image inspection apparatus according to claim 3, wherein the display unit displays a size indicator representing a size corresponding to the automatically sett detection sensitivity setting of the defect region, superimposed on the training image.

11. The image inspection apparatus according to claim 10, wherein the training execution unit allows the automatically set detection sensitivity setting of the defect region to be changed by changing a size of the size indicator through a user operation.
